(19) United States
(12) Patent Application Publication
(10) Pub. No.: US 2011/0016275 A1
(43) Pub. Date: Jan. 20, 2011

(54) MOBILE COMMUNICATION DEVICE AND METHOD FOR IMPLEMENTING MIFARE MEMORY MULTIPLE SECTORS MECHANISMS

(75) Inventors: Vincent Lemonnier, Nice (FR); Baptiste Affouard, Golfe Juan (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/920,663

(22) PCT Filed: Feb. 26, 2009
(86) PCT No.: PCT/IB09/50776

§ 371 Date: Sep. 2, 2010

(30) Foreign Application Priority Data
Mar. 4, 2008 (EP) 08290210.7

(51) Int. Cl. G06F 12/00

(52) U.S. Cl. 711/115; 711/E12.001

(57) ABSTRACT

A mobile communication device (1) comprises a MIFARE memory (MM) being configured as a MIFARE Classic card or an emulated MIFARE Classic memory and a MIFARE application manager (MAM) being adapted to install MIFARE applications in the MIFARE memory (MM). When a MIFARE application (MA) is a multiple sector application being too large to be stored in one sector of the MIFARE memory (MM) the MIFARE application manager (MAM) splits said multiple sector MIFARE application (MA) in parts (TK81-1, TK8-2, TK8-3) each being small enough for being stored in one sector of the MIFARE memory (MM), installs the parts (TK81-1, TK8-2, TK8-3) of the multiple sector MIFARE application (MA) in free sectors of the MIFARE memory (MM) and stores in the MIFARE memory (MM) an indication in which sectors the parts (TK81-1, TK8-2, TK8-3) of the multiple sector MIFARE application (MA) are located.

### FIELD OF THE INVENTION

The invention relates to a mobile communication device comprising a MIFARE Classic card or an emulated MIFARE Classic memory and a MIFARE application manager being adapted to install MIFARE applications in the MIFARE memory.

The invention further relates to a method for installing MIFARE applications in a mobile communication device that comprises a MIFARE Classic card or an emulated MIFARE Classic memory and a MIFARE application manager.

The invention further relates to a computer program product directly loadable into the memory of a mobile communication device being equipped with a MIFARE device.

The invention further relates to a mobile communication device that comprises a classic or emulated MIFARE memory and a MIFARE application manager being adapted to install MIFARE applications in the MIFARE memory.

### BACKGROUND OF THE INVENTION

The MIFARE® classic family, developed by NXP Semiconductors is the pioneer and front runner in contactless smart card ICs operating in the 13.56 MHz frequency range with read/write capability. MIFARE® is a trademark of NXP Semiconductors. MIFARE complies with ISO14443 A, which is used in more than 80% of all contactless smart cards today. The technology is embodied in both cards and card reader devices. MIFARE cards are being used in an increasingly broad range of applications (including transport ticketing, access control, e-payment, road tolling, and loyalty applications). MIFARE Standard (or Classic) cards employ a proprietary high-level protocol with a proprietary security protocol for authentication and ciphering. MIFARE® technology has become a standard for memory devices with key-protected memory sectors. One example for a published product specification of MIFARE® technology is the data sheet “MIFARE® Standard Card IC MF1 IC S50—Functional Specification” (1998) which is herein incorporated by reference. MIFARE® technology is also discussed in: Klaus Finkenzeller, “RFID Handbuch”, HANSER, 3^{rd} edition (2002).

The MIFARE Classic cards are fundamentally just memory storage devices, where the memory is divided into sectors and blocks with simple security mechanisms for access control. Each device has a unique serial number. Anticollision is provided so that several cards in the field may be selected and operated in sequence.

The MIFARE Standard 1k offers about 768 bytes of data storage, split into 16 sectors with 4 blocks of 16 bytes each (one block consists of 16 bytes); each sector is protected by two different keys, called A and B. They can be programmed for operations like reading, writing, increasing value blocks, etc. The last block of each sector is called “trailer”, which contains two secret keys (A and B) and programmable access conditions for each block in this sector. In order to support multi-application with key hierarchy an individual set of two keys (A and B) per sector (per application) is provided.

The memory organization of a MIFARE Standard 1k card is shown in FIG. 1. The 1024×8 bit EEPROM memory is organized in 16 sectors with 4 blocks of 16 bytes each. The first data block (block 0) of the first sector (sector 0) is the manufacturer block which is shown in detail in FIG. 2. It contains the serial number of the MIFARE card that has a length of four bytes (bytes 0 to 3), a check byte (byte 4) and eleven bytes of IC manufacturer data (bytes 5 to 15). The serial number is sometimes called MIFARE User IDentification (MUID) and is a unique number. Due to security and system requirements the manufacturer block is write protected after having been programmed by the IC manufacturer at production. However, the MIFARE specification allows to change the serial number during operation of the MIFARE card, which is particularly useful for MIFARE emulation cards like SmartMX cards.

Basically MIFARE card reader terminals either read only predefined sectors of MIFARE cards or browse through the entire memory in order to find a particular MIFARE application. However, in order to maintain the speed and convenience of MIFARE's tap-and-go operation, the MIFARE Application Directory (MAD) has been defined which provides common data structures for card application directory entries, allowing terminals to identify the right card (and the right memory sector within the card) without the need to perform a comprehensive search through all of the cards' memories until the appropriate application is found. A typical example is when a person has MIFARE based smart cards for both access control to his office and public transport fare collection. With the MAD, when the cardholder wants to enter his office, the access control terminal identifies the two cards and is able to choose the correct one very quickly, simply by checking the MAD. The MAD standard defines that MIFARE applications are registered on a worldwide directory and given an Application ID (AID). The MAD standard uses the registered Application IDentifiers (AIDs) by writing a look-up table of AIDs and sectors in sector 0x00 (and sector 0x10 if applicable) of the card's memory to enable identification of all registered card applications. Terminal software can then take advantage of this feature using these sector pointers instead of physical sector addresses. So an application may use e.g. sector 3 on one card, and sector 7 on another, depending on what other applications are already there.

SmartMX (Memory eXtension) is a family of smart cards that have been designed by NXP Semiconductors for high-security smart card applications requiring highly reliable solutions, with or without multiple interface options. Key applications are e-government, banking/finance, mobile communications and advanced public transportation.

The ability to run the MIFARE protocol concurrently with other contactless transmission protocols implemented by the User Operating System enables the combination of new services and existing applications based on MIFARE (e.g. ticketing) on a single Dual Interface controller based smart card. SmartMX cards are able to emulate MIFARE Classic devices and thereby makes this interface compatible with any installed MIFARE Classic infrastructure. The contactless interface can be used to communicate via any protocol, particularly the MIFARE protocol and self defined contactless transmission protocols. SmartMX enables the easy implementation of state-of-the-art operating systems and open platform solutions including JCOP (the Java Card Operating System) and offers an optimized feature set together with the highest levels of security. SmartMX incorporates a range of security features to counter measure side channel attacks like DPA, SPA etc. A true anticollision method (acc. ISO/IEC 14443-3), enables multiple cards to be handled simultaneously.

It should be noted that the emulation of MIFARE Classic cards is not only restricted to SmartMX cards, but there may also exist other present or future smartcards being able to emulate MIFARE Classic cards.

Recently, mobile communication devices have been developed which contain MIFARE devices, either being configured as MIFARE Classic cards or as MIFARE emulation devices like SmartMX cards. These mobile communication devices comprise e.g. mobile phones with Near Field Communication (NFC) capabilities, but are not limited to mobile phones.

While both MIFARE Classic cards and MIFARE emulation devices have turned out as a story of success in the market, recently wishes to install MIFARE applications that occupy more than one sector on MIFARE Classic or emulation devices have been noticed. These wishes imply new demands in respect of appropriate use of the limited memory size capacities of MIFARE devices.

### OBJECT AND SUMMARY OF THE INVENTION

It is an object of the invention to provide a mobile communication device of the type defined in the opening paragraph and a method of the type defined in the second paragraph, in which the problems mentioned above are overcome.

In order to achieve the object defined above, with a mobile communication device according to the invention characteristic features are provided so that such a mobile communication device can be characterized in the way defined below, that is:

A mobile communication device comprising a MIFARE memory being configured as a MIFARE Classic card or an emulated MIFARE Classic memory and a MIFARE application manager being adapted to install MIFARE applications in the MIFARE memory wherein when a MIFARE application is a multiple sector application being too large to be stored in one sector of the MIFARE memory the MIFARE application manager splits said multiple sector MIFARE application in parts each being small enough for being stored in one sector of the MIFARE memory, installs the parts of the multiple sector MIFARE application in free sectors of the MIFARE memory and stores in the MIFARE memory an indication in which sectors the parts of the multiple sector MIFARE application are located.

In order to achieve the object defined above, with a method according to the invention characteristic features are provided so that a method according to the invention can be characterized in the way defined below, that is:

A method for installing MIFARE applications in a mobile communication device that comprises a MIFARE memory being configured as a MIFARE Classic card or an emulated MIFARE Classic memory and a MIFARE application manager being adapted to install MIFARE applications in the MIFARE memory, wherein when a MIFARE application is a multiple sector application being too large to be stored in one sector of the MIFARE memory the MIFARE application manager splits said multiple sector MIFARE application in parts each being small enough for being stored in one sector of the MIFARE memory, installs the parts of the multiple sector MIFARE application in free sectors of the MIFARE memory and stores in the MIFARE memory an indication in which sectors the parts of the multiple sector MIFARE application are located.

In order to achieve the object defined above, a computer program product being directly loadable into the memory of a mobile communication device with a MIFARE memory being configured as a MIFARE Classic card or an emulated MIFARE Classic memory and a MIFARE application manager comprises software code portions for performing—when running on the mobile communication device—the steps of the method for installing a mobile communication device according to the above paragraph.

In order to achieve the object defined above, a mobile communication device according to the invention comprises an arithmetic-logic unit and a memory and processes the computer program product according to the above paragraph.

The present invention allows to install multiple sector MIFARE applications (which sometimes are also referred to as MIFARE (Classic) Objects (MCO)). A particular advantage of the present invention is that these multiple sector MIFARE applications don't have to be written in consecutive sectors of the MIFARE memory.

When the MIFARE memory comprises a MIFARE application directory (MAD) that contains a look-up table of MIFARE application identifiers and sectors where the MIFARE applications reside in the MIFARE memory, use can be made of this MIFARE application directory as an indication where the parts of the multiple sector application have been stored, in that the MIFARE application manager assigns in the MIFARE application directory the MIFARE application identifier of the multiple sector MIFARE application to all sectors where parts of the multiple sector MIFARE application have been installed.

When the MIFARE memory does not comprise a MIFARE application directory it is suggested in a further embodiment of the invention to split the multiple sector MIFARE application in parts each being smaller than the length of one sector of the MIFARE memory and to install each part in one separate free sector together with an indication that points to that sector where the subsequent part is installed. In order to make assembling of the parts to the original multiple sector MIFARE application easier for a reading device it may be of advantage to fully concatenate the parts by having the indication of the last part of the multiple sector memory application point to the sector of the first part of the multiple sector memory application.

In an alternative embodiment of the invention the MIFARE application manager builds a multiple parts directory for the multiple sector MIFARE application, which multiple parts directory contains a look-up table of the parts of the multiple sector MIFARE application and the sectors where said parts reside in the MIFARE memory, and writes the multiple parts directory in a free sector of the MIFARE memory, preferably in the lowest free sector.

The aspects defined above and further aspects of the invention are apparent from the exemplary embodiments to be described hereinafter and are explained with reference to these exemplary embodiments.

### BRIEF DESCRIPTION OF THE DRAWINGS

The invention will be described in more detail hereinafter with reference to exemplary embodiments. However, the invention is not limited to them.

FIG. 1 shows the memory organization of a MIFARE Standard 1k EEPROM.

FIG. 2 shows the manufacturer block of a MIFARE memory.

FIG. 3 shows the sector trailer of a sector of MIFARE memory.

FIG. 4 shows a schematic block circuit of an embodiment of a mobile communication device according to the present invention.

FIG. 5 shows a MIFARE memory representation before a multi sector MIFARE application is installed.

FIG. 6 shows the process of installing a multi sector MIFARE application according to a first embodiment of the invention.

FIG. 7 shows a representation of a MIFARE application directory as used in the first embodiment of the invention.

FIG. 8 shows the process of installing a multi sector MIFARE application according to a second embodiment of the invention.

FIG. 9 shows a representation of a MIFARE data block as used in the second embodiment of the invention.

FIG. 10 shows the process of installing a multi sector MIFARE application according to a third embodiment of the invention.

FIG. 11 shows a representation of a multiple parts directory as used in the third embodiment of the invention.

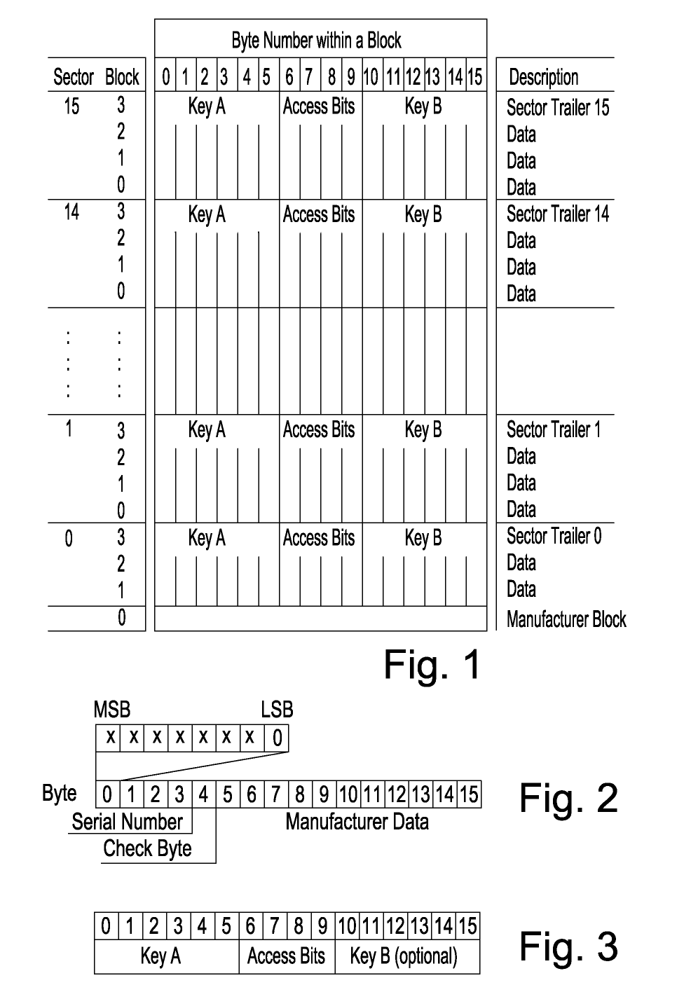

### DESCRIPTION OF EMBODIMENTS

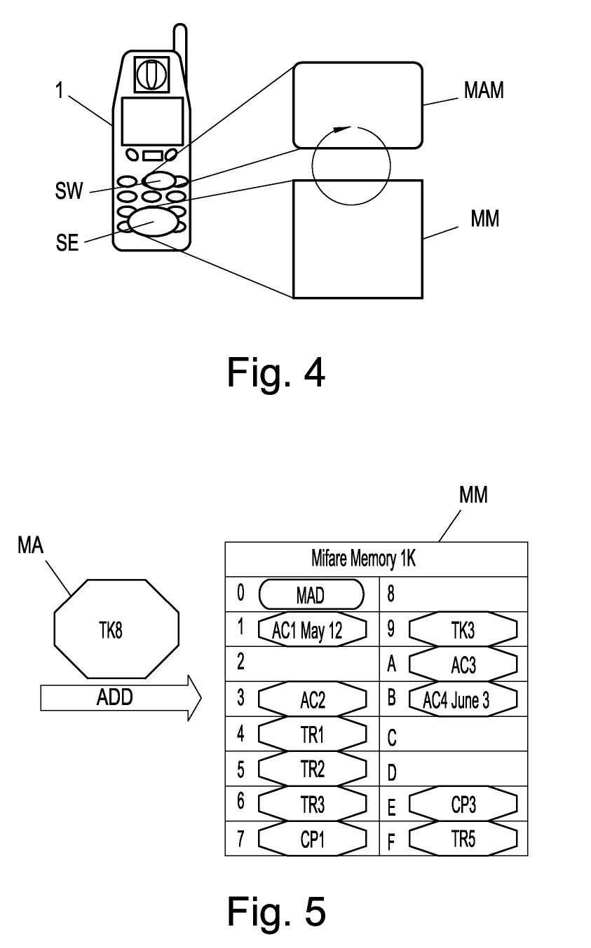

A first embodiment of the invention will now be explained in detail by reference to FIG. 4. FIG. 4 shows a schematic representation of a mobile communication device 1 being configured as mobile phone with Near Field Communication (NFC) capabilities. The mobile communication device 1 comprises a processor and memory (not shown in the drawing) for executing software SW. The software SW comprises an operating system for carrying out and managing all functions of the mobile communication device 1. The mobile communication device 1 further comprises an internal memory being controlled by the operating system of the device. The mobile communication device further comprises a secure memory element SE, such as a SmartMX card which comprises a MIFARE memory MM. The MIFARE memory MM is either configured as a MIFARE Classic card or as a MIFARE Emulation card. The MIFARE memory MM is arranged in the mobile communication device 1, either fixedly installed or being a removable card device. Let us assume that in the present example the secure element SE is a SmartMX card that comprises a memory portion that emulates the MIFARE memory MM. However, it should once more be emphasized that the MIFARE memory MM can also be a MIFARE Classic card, e.g. 1 kB or 4 kB card.

According to the invention the mobile communication device 1 comprises a MIFARE application manager MAM. In the present embodiment of the invention the MIFARE application manager MAM is a software module being contained in the software SW of the mobile communication device 1. The MIFARE application manager MAM has the ability to install MIFARE applications in the MIFARE memory MM, to read MIFARE applications from the MIFARE memory MM, and to de-install MIFARE applications from the MIFARE memory MM. MIFARE applications are for instance tickets, coupons, access controls, e-purse functions, etc.

MIFARE applications are downloaded into the mobile communication device 1 e.g. by a Service Provider sending a SMS to the mobile communication device 1 (if configured as a mobile phone), or by means of a NFC reader/writer if the mobile communication device 1 has NFC capabilities and is located within the range of such a NFC reader/writer. Other ways to install MIFARE applications in communication devices 1 comprise for instance HTTP, Https and other data transmission protocols. The downloaded MIFARE applications are handled by the MIFARE application manager MAM.

FIG. 5 shows a representation of the 1K MIFARE memory MM which has 16 sectors 0x0 to 0xF. In the present state of the MIFARE memory MM four access control MIFARE objects AC1, AC2, AC3, AC4 are installed in sectors 0x1, 0x3, 0xA and 0xB, respectively. Further, four transit MIFARE objects TR1, TR2, TR3, TR5 are installed in sectors 0x4, 0x5, 0x6 and 0xF, respectively. Similarly, two coupon MIFARE objects CP1, CP3 are installed in sectors 0x7 and 0xE, respectively. Finally, a ticket TK3 is installed in sector 0x9 of the MIFARE memory MM. All these MIFARE objects are one sector MIFARE applications, which means that each of them fits into one sector of the MIFARE memory MM. Further, the MIFARE memory MM is provided with a MIFARE Application Directory MAD residing in sector 0x0 of the MIFARE memory MM. The function of the MIFARE Application Directory MAD has been comprehensively explained in the introduction of this specification. A representation of the MIFARE Application Directory MAD will be explained below with reference to FIG. 7. It will be appreciated that sectors 0x2, 0x8, 0xC and 0xD are free.

In the representation of FIG. 5 another MIFARE object, namely a ticket TK8 has been downloaded into the mobile communication device 1 and has to be installed (arrow ADD) by the MIFARE application manager MAM in the MIFARE memory MM. The difficulty with this ticket MIFARE object TK8 is that it is a so called multiple sector MIFARE application MA that does not fit into one sector of the MIFARE memory MM, but in this example has a length that requires three sectors of the MIFARE memory MM. It can be seen from FIG. 5 that the MIFARE memory MM does not have three consecutive free sectors.

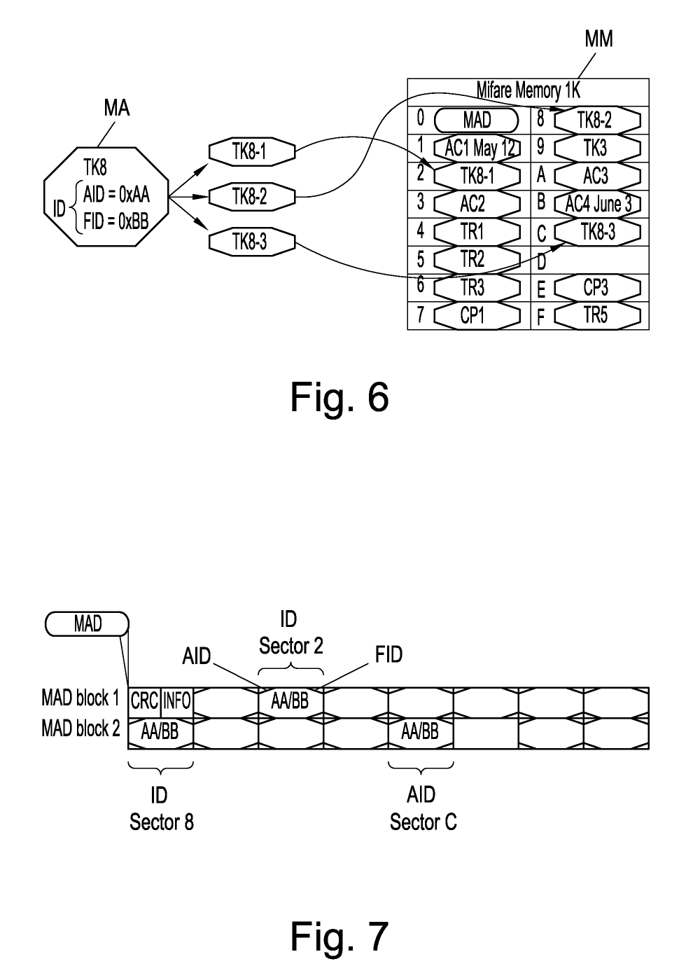

The way how the present invention solves this problem is illustrated in the representation of FIG. 6. The MIFARE application manager MAM is adapted to split the multiple sector MIFARE application MA in a number of parts such that each part is small enough to fit into one sector of the MIFARE memory MM. In this example the multiple sector MIFARE application MA has to be split into three parts TK81-1, TK8-2, TK8-3. Then the MIFARE application manager MAM installs all parts TK81-1, TK8-2, TK8-3 of the multiple sector MIFARE application MA in arbitrary free sectors of the MIFARE memory MM. In this example the first part TK8-1 is installed in sector 0x2, the second part TK8-2 is installed in sector 0x8 and the third part TK8-3 is installed in sector 0xC of the MIFARE memory MM. In order to enable a reader terminal to properly find the MIFARE object TK8 in the MIFARE memory MM the MIFARE application manager MAM additionally has to store an indication of the positions of the parts TK81-1, TK8-2, TK8-3 of the multiple sector MIFARE application MA (here ticket TK8) in the MIFARE memory MM. In this first embodiment the MIFARE application manager MM uses the MIFARE Application Directory MAD of the MIFARE memory MM to store the said indication. The MIFARE object TK8 has an application ID (AID) with the value 0xAA and a function ID FID with the value 0xBB. (It should be noticed that these values have been arbitrarily chosen for explanation of the concept of the invention.) Application ID AID and function ID FID together represent the identification ID of the MIFARE object TK8. As it is shown in FIG. 7 the MIFARE application directory MAD occupies two memory blocks (blocks 1 and 2 of sector 0x0) of the MIFARE memory and contains a look-up table of MIFARE application identifiers as well as function identifiers or generally identifiers and sectors where the MIFARE applications reside in the MIFARE memory MM. Strictly spoken, the lookup table of the MIFARE application directory MAD comprises sixteen data fields, wherein the second to sixteenth data field represent the sectors 0x1 to 0xF of the MIFARE memory MM. Since the first sector 0x0 is occupied by the MIFARE application directory MAD it cannot be used for MIFARE applications, and therefore the first data field of the lookup table can be used for special functions, namely containing a checksum CRC and an information byte INFO. According to the present invention the MIFARE application manager MAM is adapted to write the MIFARE application ID of the multiple sector MIFARE object TK8, here the values ‘AA/BB’, into all data fields that represent sectors where parts of the multiple sector MIFARE object TK8 have been stored. It is important to note that the IDs written into the data fields have the same value than that of the original ticket TK8.

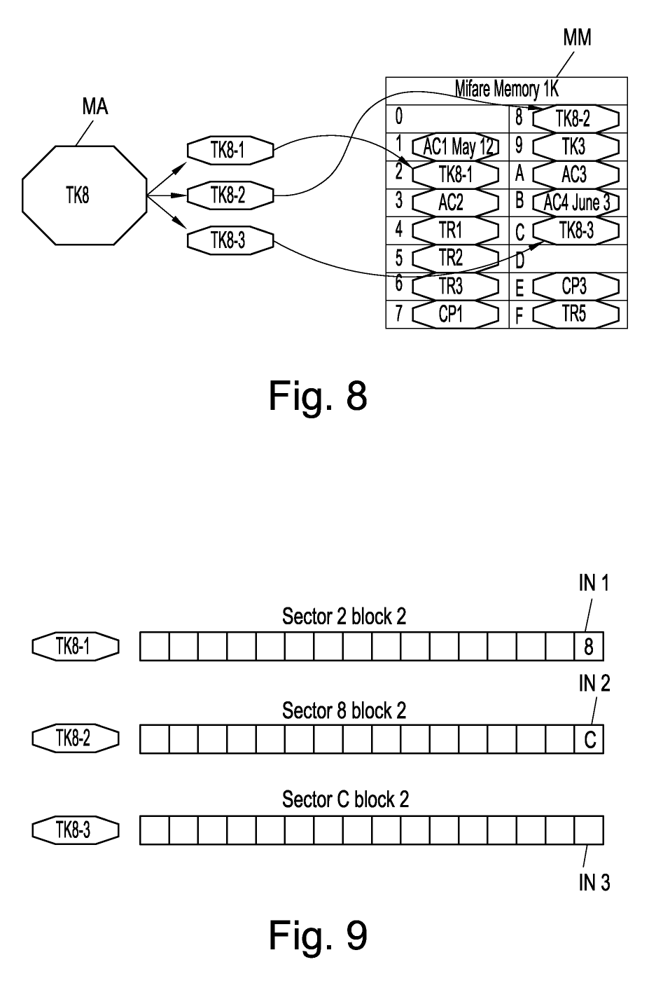

Next, a second embodiment of the invention is explained with reference to FIG. 8. This second embodiment can be applied when the MIFARE memory MM does not contain a MIFARE application directory MAD. As in the first embodiment of the invention also in this second embodiment the MIFARE application manager MAM splits the multiple sector MIFARE application MA (=ticket TK8) into three parts TK81-1, TK8-2, TK8-3 and installs them in the free sectors 0x2, 0x8 and 0xC of the MIFARE memory MM. However, in this second embodiment the MIFARE application manager MAM is adapted to split the multiple sector MIFARE application MA in parts smaller than the length of one sector of the MIFARE memory MM so that when the parts are installed there remains some free memory space in each sector that contains one of said parts TK81-1, TK8-2, TK8-3. For instance, the size of the free memory space in each sector is 1 byte. When the MIFARE application manager MAM installs the parts TK81-1, TK8-2, TK8-3 it additionally writes an indication IN1, IN2, IN3 into the free memory space which indication points to the sector where the subsequent part is installed. This concept will be better understood by turning to the MIFARE memory data block representation of FIG. 9 which shows sector 0x2, block 2 where the trailing portion of part TK8-1 resides, sector 0x8, block 2 where the trailing portion of part TK8-2 resides, and sector 0xC, block 2 where the trailing portion of part TK8-1 resides. In each of said blocks the last byte is reserved for the indications IN1, IN2, IN3. The indication IN1 associated with the first part TK8-1 contains the value 0x8, i.e. it points to the sector 0x8 where the second part TK8-2 resides. The indication IN2 associated with the second part TK8-1 contains the value 0xC, i.e. it points to the sector 0xC where the third part TK8-3 resides. The indication IN3 associated with the third part TK8-3 has been left blank, since the third part TK8-3 is the last part of the MIFARE object TK8. Nevertheless, for some reader configurations it may be useful to let the third indication IN3 point to sector 0x2 where the first part TK8-1 resides, so that all parts are concatenated with each other. A reader when reading one of the parts of the MIFARE object TK8 detects from the indications IN1, IN2, IN3, respectively, where it has to look for the next part and so on, until it has read all parts and hence the entire MIFARE object TK8.

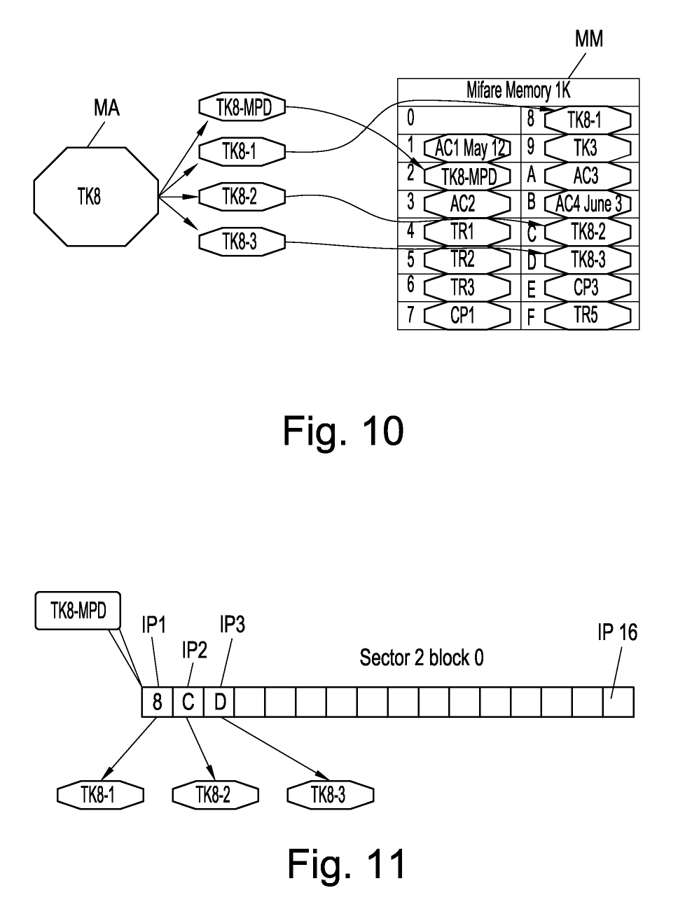

A third embodiment of the invention will be now explained with reference to FIG. 10 and FIG. 11. This third embodiment is applicable when there is no MIFARE application directory available. In this third embodiment the MIFARE application manager MAM, when splitting the multiple sector MIFARE application MA (=ticket TK8) into a number of parts (here three parts TK8-1, TK8-2, TK8-3) small enough so that each of the parts fits into one sector of the MIFARE memory MM, additionally builds a multiple parts directory MPD that contains a look-up table of the parts TK8-1, TK8-2, TK8-3 of the multiple sector MIFARE application MA and the sectors where said parts reside in the MIFARE memory MM. Strictly spoken, the lookup table of the multiple parts directory MPD comprises sixteen data fields IP1 to IP16 representing the sixteen parts into which a multiple sector application MA can at a maximum be split (when a 1K MIFARE memory is used). The first data field IP1 contains the value 0x8 which represents sector 0x8 where the first part TK8-1 is installed. (Please note that in this example the sector numbers where the parts are installed are different from those of the above examples!). The second data field IP2 contains the value 0xC which represents sector 0xC where the second part TK8-2 is installed. The third data field IP3 contains the value 0xD which represents sector 0xD where the third part TK8-3 is installed. The multiple parts directory MPD itself is also installed in a free sector of the MIFARE memory, e.g. in sector 0x2 which is the free sector with the lowest number, so that a reader when searching the MIFARE memory for MIFARE applications from the beginning will first find the multiple parts directory MPD and by analyzing the contents of the multiple parts directory MPD will immediately be directed to the sectors where the parts of the multiple sector application MA are installed. It should be noted that the multiple parts directory MPD may contain 48 bytes (=size of one sector) of data fields IPx. For MIFARE 1K, only 15 bytes are needed, for MIFARE 4K 39 bytes are needed.

The present invention is particularly applicable to the field of NFC mobile phones and OTA (Over the Air) provisioning of new services like ticketing, transit, access control etc.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The indefinite article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A mobile communication device comprising a MIFARE memory being configured as a MIFARE Classic card or an emulated MIFARE Classic memory and a MIFARE application manager being adapted to install MIFARE applications in the MIFARE memory wherein when a MIFARE application is a multiple sector application being too large to be stored in one sector of the MIFARE memory the MIFARE application manager splits said multiple sector MIFARE application in parts each being small enough for being stored in one sector of the MIFARE memory, installs the parts of the multiple sector MIFARE application in free sectors of the MIFARE memory and stores in the MIFARE memory an indication in which sectors the parts of the multiple sector MIFARE application are located.

2. The mobile communication device as claimed in claim 1, wherein the MIFARE memory comprises a MIFARE application directory that contains a look-up table of MIFARE application identifiers and sectors where the MIFARE applications reside in the MIFARE memory, and wherein the MIFARE application manager is adapted to assign in the MIFARE application directory the MIFARE application identifier of the multiple sector MIFARE application to all sectors where parts of the multiple sector MIFARE application have been installed.

3. The mobile communication device as claimed in claim 1, wherein the MIFARE application manager is adapted to split the multiple sector MIFARE application in parts each being smaller than the length of one sector of the MIFARE memory and to install each part in one free sector together with an indication that points to that sector where the subsequent part is installed.

4. The mobile communication device as claimed in claim 3, wherein the indication of the last part of the multiple sector memory application points to the sector of the first part of the multiple sector memory application.

5. The mobile communication device as claimed in claim 1, wherein the MIFARE application manager builds a multiple parts directory for the multiple sector MIFARE application, which multiple parts directory contains a look-up table of the parts of the multiple sector MIFARE application and the sectors where said parts reside in the MIFARE memory, and writes the multiple parts directory in a free sector of the MIFARE memory, preferably in the lowest free sector.

6. A method for installing MIFARE applications in a mobile communication device that comprises a MIFARE memory being configured as a MIFARE Classic card or an emulated MIFARE Classic memory and a MIFARE application manager being adapted to install MIFARE applications in the MIFARE memory, wherein when a MIFARE application is a multiple sector application being too large to be stored in one sector of the MIFARE memory the MIFARE application manager splits said multiple sector MIFARE application in parts each being small enough for being stored in one sector of the MIFARE memory, installs the parts of the multiple sector MIFARE application in free sectors of the MIFARE memory and stores in the MIFARE memory an indication in which sectors the parts of the multiple sector MIFARE application are located.

7. The method as claimed in claim 6, wherein the MIFARE memory comprises a MIFARE application directory that contains a look-up table of MIFARE application identifiers and sectors where the MIFARE applications reside in the MIFARE memory, and wherein the MIFARE application manager assigns in the MIFARE application directory the MIFARE application identifier of the multiple sector MIFARE application to all sectors where parts of the multiple sector MIFARE application have been installed.

8. The method as claimed in claim 6, wherein the MIFARE application manager splits the multiple sector MIFARE application in parts each being smaller than the length of one sector of the MIFARE memory and installs each part in one free sector together with an indication that points to that sector where the subsequent part is installed.

9. The method as claimed in claim 8, wherein the indication of the last part of the multiple sector memory application points to the sector of the first part of the multiple sector memory application.

10. The method as claimed in claim 6, wherein the MIFARE application manager builds a multiple parts directory for the multiple sector MIFARE application, which multiple parts directory contains a look-up table of the parts of the multiple sector MIFARE application and the sectors where said parts reside in the MIFARE memory, and writes the multiple parts directory in a free sector of the MIFARE memory, preferably in the lowest free sector.

11. A computer program product being directly loadable into the memory of a mobile communication device that comprises a MIFARE memory being configured as a MIFARE Classic card or an emulated MIFARE Classic memory and a MIFARE application manager, wherein the computer program product comprises software code portions for performing—when running on the mobile communication device—the steps of the method as claimed in claim 6.

12. A computer program product as claimed in claim 11, wherein the computer program product is stored on a computer readable medium or is downloadable from a remote server via a communication network.

13. A mobile communication device with an arithmetic-logic unit and a memory, wherein the mobile communication device is adapted to process the computer program product as claimed in claim 11.

14. The mobile communication device as claimed in claim 13, being configured as a mobile phone, preferably having NFC capabilities.
